(19) United States
(12) Patent Application Publication
(10) Pub. No.: US 2007/0290450 A1
(43) Pub. Date: Dec. 20, 2007

(54) Face Seal, Especially for Cooling Medium Pumps of Motor Vehicles

(75) Inventors: Klaus-Jurgen Uhrner, Leingarten (DE); Markus Schwerdtfeger, Mannheim (DE)

Correspondence Address: GUDRUN E. HUCKETT DRAUDT, SCHUBERTSTR. 15A, WUPPERTAL, 42289, DE

(73) Assignee: KACO GMBH & CO. KG, Heilbronn (DE)

(21) Appl. No.: 11/306,113

(22) Filed: Dec. 16, 2005

(30) Foreign Application Priority Data
Dec. 17, 2004 (DE) 102004062445.3

(51) Int. Cl. F16J 15/16

(52) U.S. Cl. 277/399

(57) ABSTRACT

A face seal for cooling medium pumps of motor vehicles has a slide ring and a counter ring, wherein the slide ring and the counter ring are forced seal-tightly against one another by a magnetic force of attraction. The slide ring and the counter ring are magnets or one of the rings is a magnet and the other is made from ferromagnetic material. A secondary seal is provided that secures the slide ring.

### BACKGROUND OF THE INVENTION

The invention relates to a face seal, in particular, for cooling medium pumps of motor vehicles, comprising a slide ring and a counter ring resting against one another seal-tightly under the load of a force.

For sealing a shaft passage of a cooling medium pump of motor vehicles, axial face seals are preferably used because a very high reliability is required under the partially very difficult operating conditions such as high and constantly changing rotary speed, high temperatures, cooling agents that are difficult to seal, abrasive materials being present, dry run, and vibrations. Moreover, the seals should be producible in large numbers in a fully automated process at comparatively low costs while at the same time a faultless product quality should be ensured.

FIGS. 1a and 1b show prior art face seals used for sealing cooling medium pumps of motor vehicles. These face seals are so-called unitized seals that comprise, in addition to the actual face seal itself, also a counter ring that rotates with the pump shaft. These seals are comprised conventionally of nine complex components. These components are partially difficult to produce because there is a requirement for very narrow tolerance ranges with regard to geometry and quality. The known face seals have a slide ring 16 that rests sealingly against a counter ring 18. Between the extremely precisely machined end faces of the slide ring 16 and of the counter ring 18 a seal gap 22 is formed that is kept closed by the force of a coil spring 4. The seal gap 22 provides the primary seal of the face seal.

A secondary sealing action is realized by means of a rubber bellows 5 that closes the leakage path between the slide ring 16 and a seal housing 6 in a medium-tight way.

The supporting and centering action of the pressure spring 4 or the introduction of the force of the pressure spring is realized by means of a spring plate 1a,1b (FIG. 1a). In the face seal according to FIG. 1b, the support of the pressure spring 4 embodied as cup spring 1c is realized by the bottom of the seal housing 6 and the spring plate 1c.

In the embodiment according to FIG. 1a, the spring plates 1a,1b press the bellows 5 radially inwardly in a medium-tight way against the seal housing 6 and against the slide ring 16. In the face seal according to FIG. 1b, the spring plate 1c forces the bellows 5 radially against the slide ring 16. An anti-rotation device 2 for the slide ring 16 forces the inner end of the bellows 5 axially into an appropriate annular groove of the seal housing 6 in order to seal the leakage path between the seal housing 6 and the slide ring 16 in a medium-tight way. As a result of the elastic configuration of the bellows 5, the slide ring 16 can follow under the force of the pressure spring 4 positional deviations of the counter ring 18 without this causing the sealing gap 22 to open which, in turn, would cause leakage.

The counter ring 18 is connected by means of a securing collar 3 positively and in a medium-tight way to a holder 3a that is press-fit onto the shaft to be sealed. The introduction of the friction moment at the sealing gap from the counter ring 18 into the holder 3a is realized by a suitable positive-locking configuration of the outer wall of the counter ring 18 and the engaging holder 3a extending across it. It was found to be beneficial to have two interlocking octagons. The medium-tight and positive-locking attachment of the holder 3a on the shaft is realized by means of the press-fit provided by the inner diameter of the holder 3a. A separation of the holder 3a and the face seal is prevented by crimping the end of the holder 3a that is facing the bottom of the seal housing 6.

Because of the plurality of components such face seals are expensive to manufacture. The assembly process is complex, expensive, and susceptible to errors. Moreover, the costs for the required investment and the expenditure for quality-control measures are increased.

Complicating matters is the fact that there is a trend to increasingly reduced dimensions of the mounting spaces and thus of the sealing element. For example, the axial mounting space for the pressure spring 4 of the face seals according to FIG. 1b is only approximately one-fourth of the axial length of the mounting space of the face seals according to FIG. 1a. However, this has the result that the characteristic line of the spring, because of the smaller mounting space that is available, is steeper and that, generally, as a result of the reduction in size the manufacturing tolerances of the seal components must become tighter. Such seals are therefore also significantly less tolerant in regard to deviations caused by the manufacture and caused during mounting of the seal within the device.

The known configurations of face seals are therefore typical compromise designs in which the geometric size reduction of the seal leads to the disadvantage of reduced error tolerance or an increased manufacturing expenditure.

### SUMMARY OF THE INVENTION

It is an object of the present invention to design the face seal of the aforementioned kind such that it enables large manufacturing and assembly tolerances and can be mounted inexpensively while it provides a constructively simple configuration and has a short length.

In accordance with the present invention, this is achieved in that the slide ring and the counter ring are forced sealingly against one another by a magnetic force of attraction.

In the face seal according to the invention, the force that closes the seal gap between the slide ring and the counter ring is provided by a magnetic force of attraction. Both sliding partners can be formed by a magnet, for example, an inexpensive hard ferrite magnet. However, it is also possible to make only one of these two sliding partners a magnet and to manufacture the other sliding partner from a ferromagnetic material. Since the seal gap closing force is generated by the magnetic force of attraction of the sliding partners, the pressure spring that is difficult to mount and that greatly affects the seal size it is no longer required. The face seal can be produced from only a few components. As a result of the constructively simple configuration and the minimal number of components, the face seal according to the invention can be produced and mounted very cost-effectively. In particular, a face seal of small dimensions can be produced at minimal costs. The small number of components also reduces potential error sources. As a result of the configuration according to the invention, the seal gap closing force is independent of component tolerances, mounting tolerances, and assembly tolerances.

### BRIEF DESCRIPTION OF THE DRAWING

FIG. 1a is a plan view of a face seal according to the prior art in axial section.

FIG. 1b is an illustration in accordance with FIG. 1 of a second embodiment of a face seal according to the prior art.

FIG. 2a shows in axial section a first embodiment of a face seal according to the invention (upper half of the drawing).

FIG. 2b shows a second embodiment of a face seal according to the invention (bottom half of the drawing).

FIG. 3 illustrates in axial section the secondary seal of the face seal of the first and second embodiments of the face seal according to the invention.

FIG. 4a illustrates in axial section a third embodiment of the face seal according to the invention.

FIG. 4b illustrates in axial section the secondary seal of the third embodiment of the face seal in an initial position.

FIG. 4c illustrates in axial section the secondary seal of the third embodiment of the face seal in an intermediate position.

FIG. 5 shows in axial section of fourth embodiment of the face seal according to the invention.

FIG. 6a shows in axial section a fifth embodiment of the face seal according to the invention.

FIG. 6b shows in axial section a sixth embodiment of the face seal according to the invention.

FIG. 7a illustrates in axial section a seventh embodiment of the facing according to the invention.

FIG. 7b illustrates detail B of FIG. 7a.

### DESCRIPTION OF THE PREFERRED EMBODIMENTS

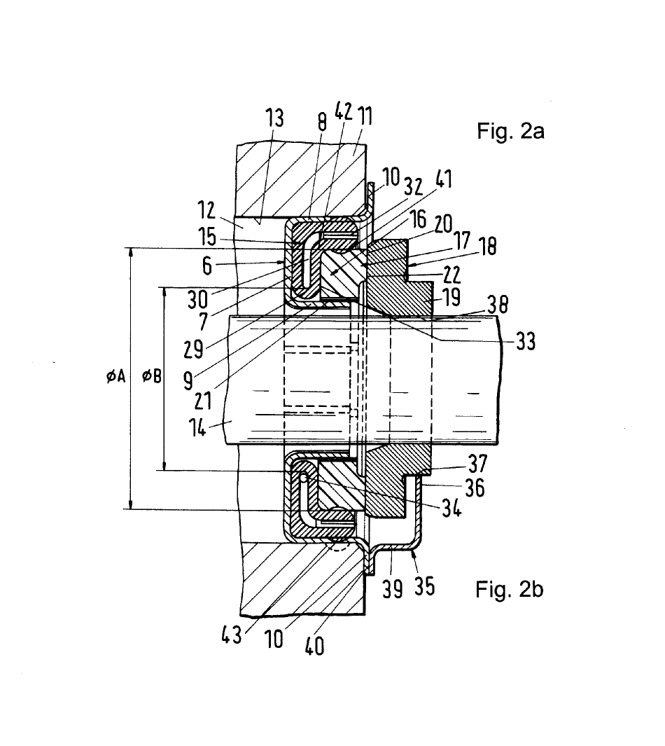

FIG. 2a (upper half of the drawing) shows a face seal used advantageously for sealing a cooling medium pump of motor vehicles. The face seal has a seal housing 6 with a radially extending annular bottom 7 that is adjoined by radially outer and radially inner circumferential housing walls 8 and 9. The radially outer circumferential housing wall 8 is provided at its free end with a radial outwardly oriented flange 10. By means of the flange 10, the seal housing 6 rests against a pump housing 11 in the illustrated mounted position. The pump housing 11 has a mounting space 12 with a wall 13; the outer housing wall 8 of the seal housing 6 rests seal-tightly against the wall 13 by press-fit. The radially inner cylindrical housing wall 9 surrounds a shaft 14 to be sealed at a minimal spacing.

In the seal housing 6, a secondary seal 15 is arranged that secures a slide ring 16. The slide ring 16 projects with a radial sliding surface 17 axially past the inner housing wall 9, and the sliding surface 17 rests seal-tightly against a counter ring 18. The counter ring 18 has a hub 19 and is axially fixedly secured with its hub 19 on the shaft 14 and is also secured thereon for common rotation with the shaft 14. The counter ring 18 rests with a radial counter surface 20 sealingly against the sliding surface 17 of the slide ring 16.

The slide ring 16 is connected fixedly to the seal housing 6 for common rotation with the seal housing 6. In the illustrated embodiment, the housing wall 9 has an angular or polygonal cross-section. Accordingly, the radial inner sidewall 21 of the slide ring 16 is of a polygonal configuration in cross-section. In the illustrated embodiment, the housing wall 9 as well as the sidewall 21 are shaped as an octagon. In this way, a reliable anti-rotation protection device is provided for the slide ring 16.

The slide ring 16 and the counter ring 18 can be configured each as a magnet. The magnets are mounted in such a way that they attract one another. It is also possible to configure only the slide ring 16 or only the counter ring 18 as a magnet and to embody the other sliding partner of a ferromagnetic material, respectively. The two sliding partners 16, 18 are pulled against one another by magnetic force. In this way, the closing force for the radial seal gap 22 is generated by the magnetic force of attraction acting between the sliding partners 16, 18. About the circumference of the slide ring 16 and of the counter ring 18 a uniform force distribution results in this way. In the case of mass production, fluctuations of the seal gap closing force can be kept very small as a result of this configuration.

Since in this face seal the seal gap closing force is not generated by a compression of a spring, the closing force also is not dependent on the configuration, mounting, or assembly tolerances. This is a significant advantage because the seal tightness as well as the friction in the seal gap 22 and thus the seal gap temperature are controlled by means of the seal gap closing force.

Since no spring is employed in the face seal, mounting of a spring and of the associated spring plate are not required. Since these components of prior art face seals are not provided, they must not be mounted, cannot be lost or forgotten during mounting, they do not create any costs, and they require no mounting space.

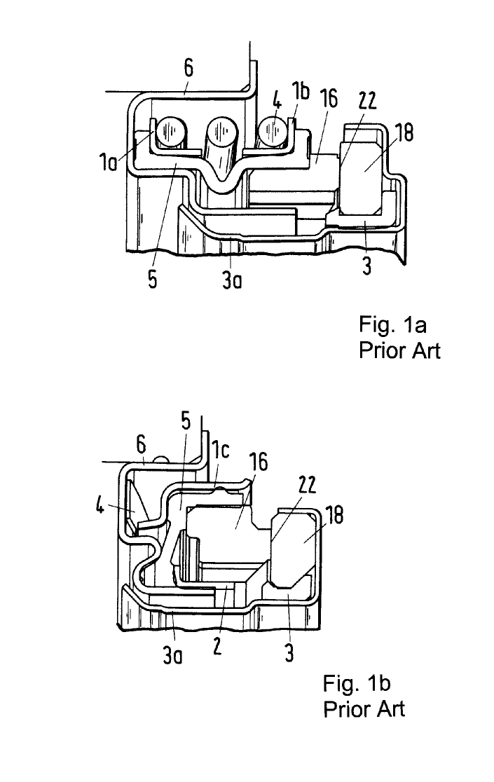

Since between the slide ring 16 and the counter ring 18 a magnetic force of attraction is present, the holder for the counter ring 18 is not needed. Accordingly, not only the holder as a complex part that is difficult to produce is no longer needed but also a holding sleeve as it is required in prior art face seals (FIG. 1a and 1b) for providing a static seal tightness between the counter ring and the holder is no longer needed. Since the counter ring 18 is directly press-fit onto the shaft 14, potential leakage paths that are present in prior art face seals between the counter ring and the holding sleeve, between the holding sleeve and the holder, as well as between the holder and the shaft are eliminated. There remains only one possible leakage path between the counter ring 18 and the shaft 14. The risk in regard to secondary leakage of the face seal is thus significantly reduced.

Of course, in the face seal according to FIG. 2a a holder and a holding sleeve for the counter ring 18 can be employed. However, these components are not required.

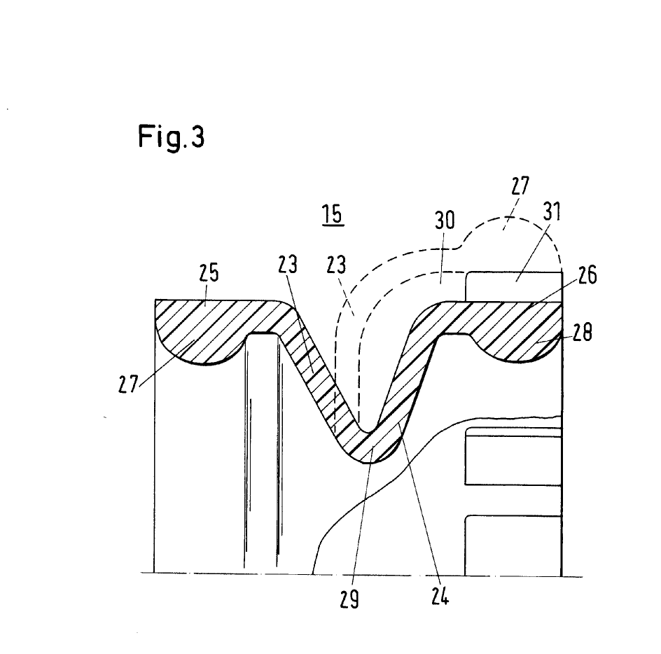

Based on FIG. 3, the manufacture of a secondary seal 15 will be explained in more detail. With solid lines the shape of the secondary seal 15 directly after its manufacture is illustrated. The secondary seal 15 is manufactured advantageously by injection molding and is subsequently vulcanized. In axial section, it is essentially V-shaped and has two conical wall parts 23, 24 that are positioned at an acute angle to one another and are oriented at a slant inwardly; they have an arc-shaped transition into one another. At the outer end, the conical wall sections 23, 24 pass into cylindrical parts 25, 26. They are provided at their inner side with beads 27, 28 that in axial section have a shape of a semi-circle.

For inserting the secondary seal 15 into the seal housing 6, the conical wall part 23 and the adjoining cylindrical part 25 are bent elastically about the V-tip 29 in such a way that the cylindrical part 25 is positioned opposed to the cylindrical part 28 at a spacing (see dashed lines in FIG. 3). Between the cylindrical parts 27, 28 and the conical wall parts 23, 24 a pressure chamber 30 is formed that in axial section is L-shaped and is open in the direction toward the medium to be sealed. Upon insertion into the seal housing 6 the radially outwardly oriented bead 27 is elastically deformed by the housing wall 8 so that a proper sealing action between the secondary seal 15 and the housing wall 8 is achieved. As shown in FIG. 2a, the secondary seal 15 rests with the cylindrical part 25 and a portion of the conical wall section 23 sealingly against the inner side of the outer wall 8 in its deformed position. The remaining part of the conical wall section 23 is positioned against the inner side of the housing bottom 7 in a seal-tight way. The bent V-shaped tip 29 in the mounted position of the secondary seal 15 is positioned at a minimal spacing relative to the radially inner wall 9 of the seal housing 6. The slide ring 16 contacts in the mounted position the conical wall section 24 of the secondary seal 15. When inserting the slide ring 16, the bead 28 is elastically deformed so that the slide ring 16 is secured properly by the secondary seal 15.

FIG. 3 shows that on the outer side of the cylindrical part 26 of the secondary seal 15 ribs 31 are provided as spacers that extend in the illustrated embodiment across the axial width of the bead 28. The ribs (spacers) 31 ensure in the elastically deformed mounting position of the secondary seal 15 that the seal gap 30 remains open, i.e. an inlet area is provided. The ribs 31, distributed about the circumference of the secondary seal 15, form passages 32 (FIG. 2a) for the medium to be sealed. The medium can therefore flow between the ribs 31 into the seal gap 30 of the secondary seal 15. Since it remains under elastic tension in accordance with the disclosed fold-over step, the secondary seal remains in the illustrated mounted position.

The secondary seal 15 can also be folded from the initial position indicated in solid lines in FIG. 3 such that the sealing bead 28 is folded onto the sealing bead 27. Which one of the beads 27, 28 becomes the outer or the inner sealing bead in the mounted position of the secondary seal is determined thus only after the described fold-over step after producing the secondary seal 15.

The medium to be sealed can flow through the passages 32 into the pressure chamber 30. The pressure chamber is subjected to the same pressure as the medium to be sealed. This pressure acts onto the annular surface resulting from the two following diameters. The diameter A in FIGS. 2a, 2b characterizes the seal gap entry diameter at the medium side; the diameter B indicates the smallest diameter of the pressure chamber 30. Since the pressure chamber 30 is supported by the secondary seal 15 on the bottom 7 of the seal housing 6, the medium in the pressure chamber 30 exerts a force through the secondary seal 15 onto the rear side 33 of the slide ring 16, which force is determined by the annular surface determined by the two diameters A and B multiplied by the medium pressure; in this way, the medium thus increases, as a function of the pressure of the medium to be sealed, the seal gap closing force. In this way, there is no risk of an unnecessarily high closing force with all its disadvantages when the pressure of the medium to be sealed is smaller than the maximum pressure.

The slide ring 16 is floatingly supported in the secondary seal 15 as if positioned on a waterbed and can therefore easily follow possible positional deviations of the counter ring; this is important for a secure sealing action.

Since cooling systems of motor vehicles are filled at underpressure, the face seal must seal relative to overpressure as well as underpressure. In this connection, it must be ensured that the secondary seal 15 is not pulled out of the mounting position illustrated in FIGS. 2a, 2b by the underpressure. This is prevented in that the secondary seal 15 almost completely engages across the rear side 33 of the slide ring 16. Should this measure be insufficient to prevent the secondary seal 15 from being pulled out by underpressure, it is possible, as shown in FIG. 2b, to insert a wire ring 34 into the pressure chamber 30. Advantageously, the diameter of the wire ring 34 is so large that in the mounting position it rests against the radially inwardly positioned end of the seal or pressure gap 30. The wire ring 34 prevents that the secondary seal 15 is pulled by underpressure out of the seal housing 6. The wire ring 34 can be inserted simply before the described elastic deformation of the secondary seal 15.

FIG. 2b shows the possibility of captively connecting the sliding partners 16, 18 by a centering part on the form of a cap 35. The centering part or cap 35 has a protective function in case that, during handling or transport of the face seal, such great forces are acting on the counter ring 18 that they move the counter ring despite the magnetic force of attraction out of the center position or even separate the counter ring 18 from the slide ring 16. The cap 35 centers the counter ring 15 in that it has at its bottom 36 a central opening 37 whose diameter corresponds to the outer diameter of the hub 19 of the counter ring 18. The counter ring 18 projects with its hub 19 through the opening 37 and is centered in this way relative to the slide ring 16. The diameter of the opening 37 is somewhat greater than the outer diameter of the hub 19 so that the counter ring 18 can rotate together with the shaft 14 properly relative to the fixed cap 35. As a result of this centering action, the pump shaft 14 meets during mounting of the face seal properly the seat 38 of the hub 19 of the counter ring 18.

The cap 35 surrounds with its cylindrical wall 39 the counter ring 18 at a sufficient spacing. The wall 39 has at the its free end a radially outwardly oriented flange 40 with which it is attached radially outwardly to the radially outwardly oriented flange 10 of the seal housing 6, for example, by crimping, by gluing, by laser welding, or by other suitable methods.

The cap 35 has moreover the function of a dry run protective device and serves for receiving and centering the face seal during mounting in the mounting space 12 of the device.

In other respects, the face seal according to FIG. 2b is identical to the embodiment of FIG. 2a.

Since the anti-rotation device 9, 21 is located at the inner contour of the slide ring 16, the outer wall 41 can be cylindrical. This has the advantage that this outer wall 41 of the slide ring 16 can be machined inexpensively by centerless grinding should this be necessary.

The area of the secondary seal 15 in which the beads 27, 28 are located is wider in the radial direction than the annular gap between the housing wall 8 and the outer wall 41 of the slide ring 16. This has the result that this area of the seal 15 is radially compressed between slide ring 16 and seal housing 6. In this way, the slide ring 16 is exactly centered and this leads to a reduction of leakage. As a result of this configuration, the slide ring 16 is dampened in the axial and radial directions relative to vibrations; this reduces the risk of noise development across the sealing gap 22 at least noticeably. Finally, the sealing seat 42 between the secondary seal 15 and the inner side of the housing wall 8 is improved in that the medium to be sealed in the seal gap or pressure chamber 30 presses the secondary seal 15 against the housing wall 8. In this way, even housings 6 made from very thin sheet metal, for example, having a sheet metal thickness of less than 0.3 mm, can be used and provide a safe static sealing action relative to the pump housing 11. The sealing action can be enhanced by a sealing bead 43 (FIG. 2b) that is circumferentially applied to the exterior of the housing wall 8. It is elastically deformed upon mounting of the seal housing 6 in the mounting space 12 and ensures optimal static sealing action.

Since the sealing seat 42 is very elastic in the radial direction because of the thin housing wall 8 and the elastic support by the bead area 27, 28 of the secondary seal 15, the face seal is suitable especially well for the use in plastic pump housings in which the diameter tolerances of the mounting space 12 as well as its deviation from a circular shape can be significantly greater than in the case of mechanically machined metal housings.

As illustrated in FIGS. 2a and 2b, the secondary seal 15 is designed such that the medium to be sealed cannot escape between the seal housing 6 and the slide ring 16. This is achieved in that the bead area 27, 28 of the secondary seal 15 is shaped like an O-ring that is pressed radially between the housing wall 8 and the slide ring 16. Because of its (rubber) elastic properties, this sealing area rests medium-tightly against the inner wall surface of the seal housing 6 and against the outer wall 41 of the slide ring 16.

When the medium to be sealed is under overpressure, the overpressure acts also in the seal gap 22 between the slide ring 16 and the counter ring 18. This overpressure has the tendency to separate the two sliding partners 16, 18 against the magnetic force of attraction. When this occurs, the seal gap 22 opens and this causes leakage. In order to prevent this effect, the seal gap closing force must be increased in accordance with the maximum medium pressure. This is achieved in the described way in that the secondary seal 15 has the seal gap or pressure chamber 30. By means of this gap or chamber, in the way described above, the closing force acting on the seal gap 22 is automatically adjusted as a function of the pressure to be sealed. When the medium pressure is lower, the seal gap closing force is also correspondingly reduced so that an unnecessarily high friction causing a correspondingly high seal gap temperature in accordance with the friction moment is avoided and wear is thus also prevented. When the medium pressure increases, it acts through the seal gap (pressure chamber) 30 onto the slide ring 16 so that the slide ring 16 is pressed stronger against the counter ring 18 in this way. Because of this automatic adjustment of the seal gap closing force as a function of the respective medium pressure, an optimal wear behavior together with a proper sealing action are provided.

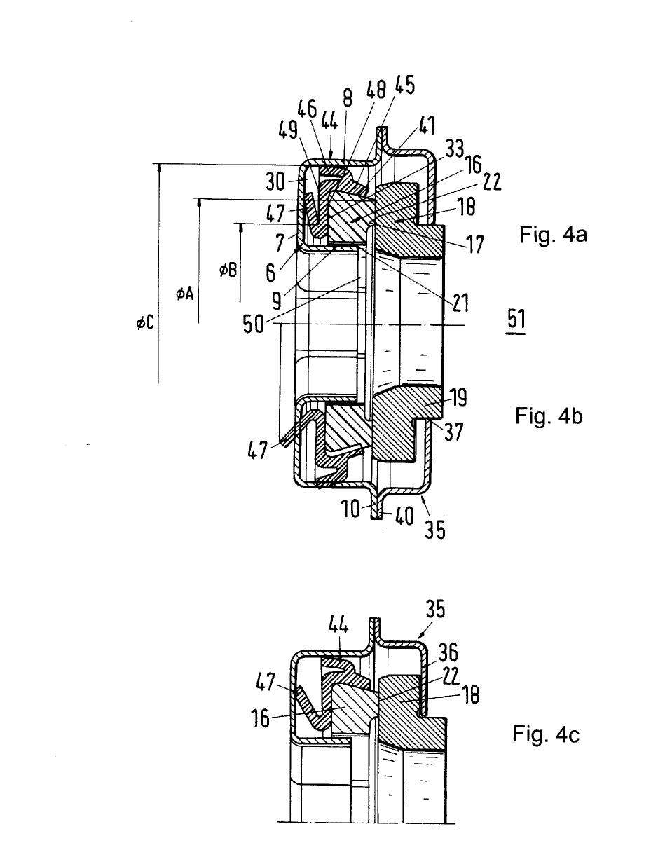

FIGS. 4a to 4c show an embodiment in which the secondary seal 44 is configured as a lip seal. In comparison to the embodiment according to FIG. 3, such a secondary seal can be produced in a simple way.

The secondary seal 44 has a first sealing lip 45 that seals relative to the medium overpressure by resting against the outer wall 41 of the slide ring 16. The outer wall 41, in contrast to the preceding embodiments, is not cylindrical but conical. The outer diameter of the slide ring 16 tapers in the direction toward the counter ring 18.

The secondary seal 44 has a second sealing lip 46 that sealingly rests against the inner wall surface of the housing wall 8. The sealing lip 46 is oriented in opposite direction relative to the sealing lip 45 and extends in the direction toward the bottom 7 of the seal housing 6. The sealing lip 46 is positioned with its free end closely adjacent to the housing bottom 7 and rests sealingly against the housing wall 8. By means of this circumferential sealing lip 46 the slide ring 16 is centered in the seal housing 6. Moreover, the second sealing lip 46 acts as an overflow valve. Once the pressure of the medium surpasses a predetermined value, the sealing lip 46 lifts off the housing wall 8 and releases a path for the medium to be sealed into the seal gap or pressure chamber 30. The seal gap 30 is limited in the direction toward the inner housing wall 9 by a third sealing lip 47 that rests seal-tightly with its free end against the housing bottom 7.

The sealing lip 47 passes in the vicinity of the inner housing wall 9 by means of an arc-shaped transition into an annular support portion 48 with which the secondary seal 44 rests against the radial plane rear side 33 of the slide ring 16. This support part 48 passes into the sealing lip 45. The support part 48 and the sealing lip 45 engage across the rear side as well as the outer side of the slide ring 16. The slide ring 16 is safely secured in this way.

The medium that is under high pressure can flow across the sealing lip 46 and can be collected in the seal gap or pressure chamber 30. By means of the medium under pressure within the chamber 30, the sealing lip 47 is forced tightly against the bottom 7 of the seal housing 6. Moreover, the medium pressure acts on the rear side 49 of the support part 48 facing away from the slide ring 16. This has the result that, as a function of the pressure of the medium, the slide ring 16 is pressed at a higher or a lower force against the counter ring 18. As in the preceding embodiments, the closing force on the seal gap 22 between the sliding partners 16 and 18 is automatically adjusted to the medium pressure in this way.

The sealing lip 46 seals moreover the air side 50 of the face seal relative to underpressure present during filling of the cooling system.

The sealing lip 47 seals the air side 50 relative to the seal gap or pressure chamber 30. The slide ring 16 is secured against rotation in accordance with the preceding embodiments on the inner housing wall 9. In accordance with the preceding embodiments, between the slide ring 16 and the housing wall 9 an annular gap is formed that opens toward the air side 50.

The hub 19 of the counter ring 18 projects according to the embodiment of FIG. 2b through the central opening 37 of the cap 35. The cap 35 is connected in the described way by means of flange 40 to the housing flange 10.

FIG. 4b shows the shape of the secondary seal directly after its manufacture. A comparison with FIG. 4a shows that the sealing lip 47 upon mounting of the secondary seal in the seal housing 6 is elastically deformed so that it rest with pretension against the bottom 7 of the seal housing 6. When the face seal is not yet mounted, the secondary seal exerts a force resulting from the elastic pretension on the slide ring 16 and onto the counter ring 18 so that the counter ring 18 is moved until it comes to rest against the bottom 36 of the cap 35 (FIG. 4c). In this way, the slide ring 16, the counter ring 18, and the secondary seal 44 during the transport and handing are properly secured against movement. Because of the magnetic force of attraction between the two sliding partners 16 and 18, it is also ensured that the seal gap 22 during transport and handling remains closed at all times and that contamination cannot occur.

Since the pressure chamber 30 is closed toward the medium side 51 by means of the sealing lip 46 and toward the air side 50 by means of the sealing lip 47, the maximum occurring medium pressure remains within the sealing chamber 30 even when the pressure in the medium to be sealed drops at the medium side 51. The seal gap or pressure chamber 30 thus forms a pressure reservoir; this has the advantage that the seal gap closing force component that results from the operating pressure and the effective surface increases with decreasing medium pressure because the counter-acting force resulting from the effective surface and the medium pressure decreases with decreasing medium pressure. The effective annular surface responsible for the resulting seal gap closing force component is determined by the difference between the diameters C and B. The annular surface determining the counter-acting force is determined by the difference of diameters C and A. The diameter C is the inner diameter of the outer housing wall 8, the diameter B is the inner diameter of the sliding surface 17 of th slide ring 16, and the diameter A is the outer diameter of the sliding surfaces 17 of the slide ring 16. As in the preceding embodiment, the strength of the hydraulic seal gap closing force component can be determined by appropriate dimensioning of the sliding surface 17 by selecting the diameters A and B appropriately.

The secondary seal 44 can be provided for a face seal that is not provided with the cap 35. In this case however the slide ring 16, the counter ring 18, and the secondary seal 44 are not secured against movement during transport and handling.

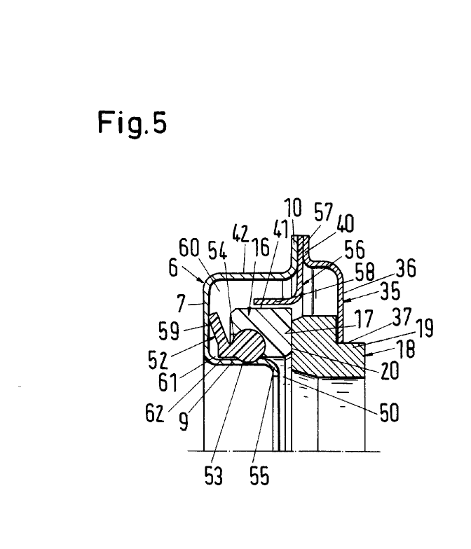

The face seal according to FIG. 5 has a secondary seal 52 that is constructively significantly simpler than the secondary seals of the preceding embodiments. The secondary seal 52 has an O-ring 53 for generating the sealing action. It is positioned in a recess 54 of the slide ring 16. The recess 54 is open toward the bottom 7 and the inner housing wall 9. In the mounted position, the O-ring 53 rests with elastic deformation in the recess 54 and seals the slide ring 16 relative to the inner wall 9 of the seal housing 6. The free edge 55 of the inner housing wall 9 is bent at a right angle radially inwardly.

The transfer of the seal gap friction moment from the slide ring 16 into the seal housing 6 is realized by a friction moment receptacle 56 that has a radial flange 57 that is fastened between the radially outwardly oriented flange 10 of the seal housing 6 and the radially outwardly oriented flange 40 of the cap 35. Advantageously, it is connected by laser welding to the seal housing 6 and the cap 35. The flange 57 however can also be a unitary or monolithic part of the seal housing 6 or of the cap 35.

The flange 57 projects from a hollow body 58 that is configured as a polygon, for example, has an octagonal contour. The outer circumferential surface 41 of the slide ring 16 is of a matching polygonal configuration. The slide ring 16 is inserted with minimal play into the hollow body 58. In this way, the slide ring 16 is axially freely movable but is positively secured in the friction moment receptacle 56 in the rotational direction. Moreover, the slide ring 16 can move like a cardanic or universal joint within the radial play between the inner side of the hollow body 58 and the outer wall surface 41 (i.e., the slide ring is tiltable to a limited extent).

The radial plane sliding surface 17 of the slide ring 16 rests sealingly against the radial plane counter surface 20 of the counter ring 18. The counter ring 18 has a hub 19 that, in accordance with the preceding embodiments, projects through the central opening 37 provided in the bottom 36 of the cap 35.

A circumferentially extending sealing lip 59 adjoins the O-ring 53 in the direction toward the bottom 7 of the seal housing 6 wherein the sealing lip 59 extends at a slant radially outwardly and rests sealingly against the inner side of the housing bottom 7. The sealing lip 59 seals an inner chamber 60 that is filled in operation of the face seal with a medium relative to the air side 50. The sealing lip 59 acts as a rubber spring that has mainly the task of forcing the counter ring 18 during transport and handling of the face seal by means of the slide ring 16 against the inner side of the bottom 36 of the cap 35. Upon pressing the counter ring 18 onto the shaft 14 (FIG. 2), the counter ring 18 and thus the slide ring 16 are moved against the force of the sealing lip 59 in the direction toward the housing bottom 7. The counter ring 18 is thus released from the bottom 36 of the cap 35 so that it can rotate without impairment with the shaft when the face seal is in use.

Between the sealing lip 59 and the O-ring 53 a short annular intermediate part 61 is provided that surrounds the housing wall 9 at a minimal spacing. At the transition from the intermediate part 61 into the sealing lip 59 an annular underpressure support 62 is provided that rests against the inner wall surface of the housing wall 9. This annular underpressure support 62 prevents that, when underpressure is present, the O-ring 53 is pulled out of its proper position in the recess 54 of the slide ring 16. Motor vehicle cooling systems are usually filled with underpressure. This entails the risk that the O-ring 53 can be pulled out of the recess 54 by underpressure. In this case, the support 62 contacts the inner wall surface of the housing bottom 7 first before the O-ring 53 can escape from the recess 54 in the slide ring 16.

An important advantage of this configuration is that with identical diameter of the shaft to be sealed the diameter of the sealing seat 42 of the seal housing 6 can be adjusted easily to the customer requirements without the inwardly positioned sealing components having to be changed.

The face seals according to FIGS. 2 through 5 are seals that are ready to be mounted and are surrounded by the seal housing 6 and optionally the cap 35. Particularly when the face seals are provided with the cap 35, the face seals can be transported and handled without problem without there being the risk of damaging the seal or the seal parts. Since the pump housings are usually made from metal the mounting spaces 12 of the pump housing 11 (FIG. 2) are precisely machined for the seal seat of the seal housing 6. However, in the recent past there has been a clear trend to smaller pump sizes and thus also to smaller seal sizes. Moreover, the pump housings 11 are produced more and more from plastic material instead of metal. This is true in particular for electrically operated cooling medium pumps. The face seal should also be suitable for the mounting space 12 of unmachined diecast metal pump housings or injection-molded plastic pump housings. The mounting expenditure should moreover be reduced to a minium and the manufacturing costs for the face seal should be reduced to a minimum.

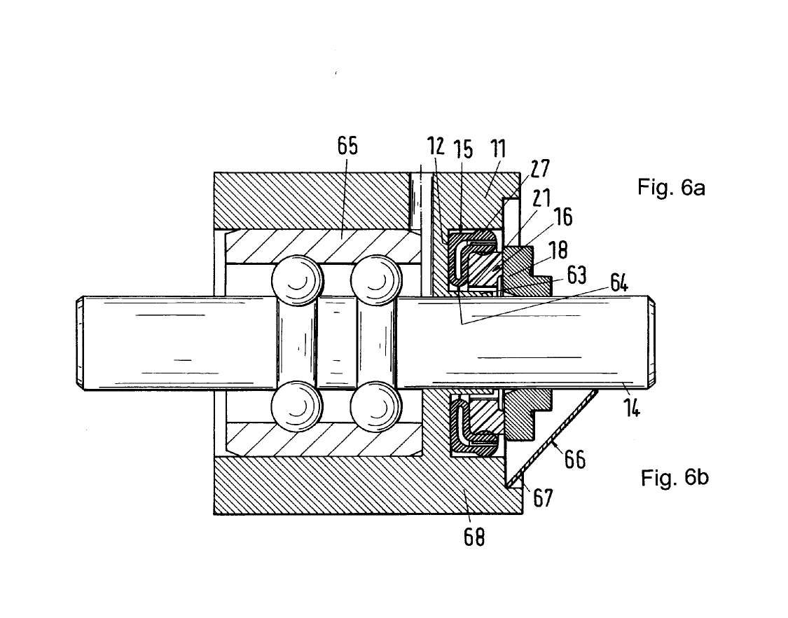

In order to fulfill these requirements, in the embodiments according to FIGS. 2a, 2b and 4a-4c the seal housing 6 can be omitted and the inner contour of the seal housing can be provided on the pump housing 11. The remaining seal components, i.e., the slide ring 16, the counter ring 18, and the secondary seal 15, 44, can be arranged directly in the pump housing 11. FIG. 6a shows such a configuration and arrangement of the face seal embodied in accordance with FIGS. 2a, 2b. The anti-rotation protection for the slide ring 16 is achieved in that it is connected positive-lockingly to the pump housing 11. The inner sidewall 21 of the slide ring 16 has a polygonal, preferably, octagonal contour. The mounting space 12 of the pump housing 11 for the face seal is limited radially inwardly by a tubular housing projection 63 that surrounds the shaft 14 with play. The outer wall surface 64 of the housing projection 63 has a contour that matches that of the slide ring side wall 21. In other respects, the face seal is of identical configuration as in the embodiment according to FIG. 2a. By eliminating the seal housing the costs for this housing as well as the costs for mounting the seal components in this housing and also the costs for the sealing bead 43 (Fig. to be) are saved. The static sealing action relative to the pump housing 11 is realized no longer by means of the metallic sealing seat of the seal housing 6 but by the (rubber) elastic seal area 27, 28 of the secondary seal 15. This has the advantage that for the mounting space 12 greater diameter variations and shape tolerances are permissible in comparison to the metallic housing seat in the case of a metal pump housing. In this way, the typical injection molding tolerances or variations can be reliably dealt with when the pump housing 11, for example, is made from plastic material. Moreover, the potential leakage path between the inner wall of the mounting space and the seal housing that occurs in the case of metallic pump housings 11 and face seals having a metallic seal housing 6 is eliminated.

FIG. 6a shows that the face seal is positioned upstream of a roller bearing 65 for the shaft 14.

As illustrated in FIG. 6b, this embodiment can be provided. with a dry run protection device. For this purpose, instead of the cap 35 of the embodiment according to FIG. 2b, a spring plate-like cap 66 is provided as a centering part on the pump housing 11. The cap 66 is conical and snapped into place with its radial outer edge into an end face recess 67 of an annular projection 68 of the pump housing 11. The radial inner edge of the cap 66 surrounds the shaft 14 with minimal play. The cap 66 is spaced from the counter ring 18 that is fastened on the shaft 14 in the way described above. Like the cap 35 of the embodiments according to FIGS. 2b, 4a-c, 5, the cap 66 also serves for receiving a portion of the medium to be sealed. In this way, in an emergency situation a limited volume of medium is available as a protection against dry run (dry run reservoir).

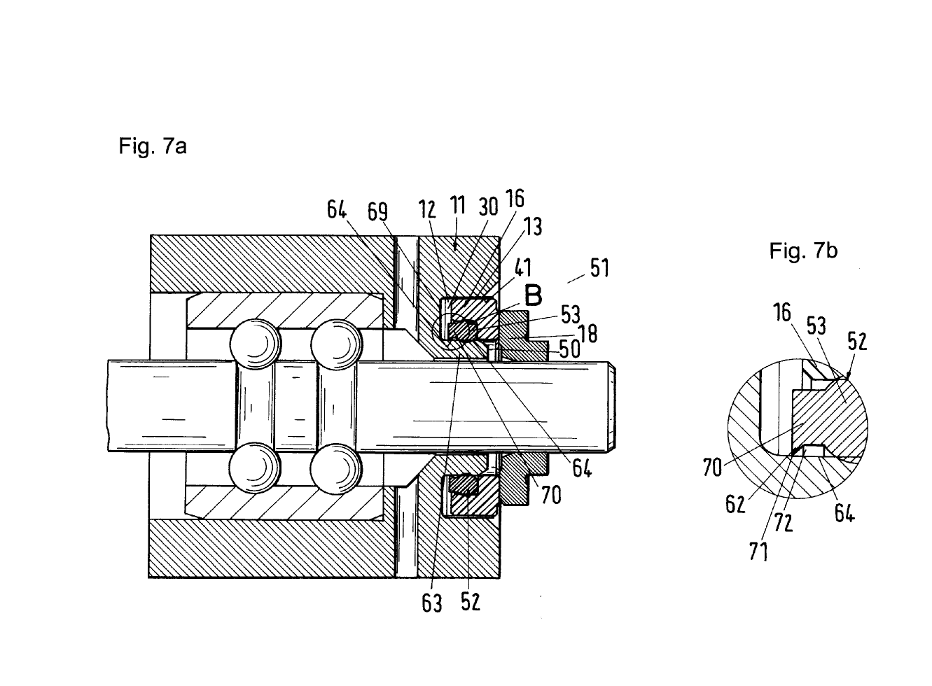

A further reduction of the mounting space for the face seal is possible with an embodiment in accordance with FIG. 7. This face seal is configured similar to the embodiment of FIG. 5. The secondary seal 52 has an O-ring 53 that seals between the slide ring 16 and the wall surface 64 of the housing projection 63 the medium side 51 relative to the air side 50. A ring 70 adjoins the O-ring 53 in the direction toward the bottom 69 of the mounting space 12 of the pump housing 11; the ring 70 is coaxial to the shaft 14 and ends at a spacing from the bottom 69 of the mounting space 12. At the free end, the ring 70 is provided with an annular support 62 (FIG. 7b) that extends across the circumference of the ring 70 and, in accordance with the embodiment of FIG. 5, rests with an edge 71 against the wall surface 64 of the housing projection 63 in a seal-tight way.

As in the embodiment according to FIGS. 6a, 6b, the face seal has no housing. The face seal is inserted without housing directly into the mounting space 12 of the pump housing 11. The counter ring 18 is mounted on the shaft 14. The slide ring 16 has an outer diameter that is smaller than the inner diameter of the mounting space 12. Thus, the medium can pass through with the annular gap formed in this way into the pressure chamber 30.

The ring 70 forms an underpressure support that prevents the O-ring 53 from being pulled out of its operating position in the case of underpressure filling of the system. When underpressure occurs, the O-ring 53 can be moved only so far out of its operating position until its annular projection 70 contacts the bottom 69 of the mounting space 12. At this point, the O-ring 53 has moved only a little bit away from its operating position.

The annular support 62 on the ring 70 can be eliminated (FIG. 7a) without this impairing the function of the face seal. The support 62 according to FIG. 7b has the advantage that between it and the O-ring 53 a lubricant reservoir 72 can be provided that can be filled with a suitable protective lubricating agent. The lubricant reservoir 72 is limited radially outwardly by the ring 70 and radially inwardly by the wall surface 64 of the housing projection 63. The support 62 prevents that the medium to be sealed can escape from the pressure chamber 30 into the lubricant reservoir 72.

Modern cooling agents can be aggressive toward an O-ring 53 that is advantageously made from rubber material. Because of this, deposits from the cooling medium can collect in the area of the lubricant reservoir 52 when the support 62 is not provided (FIG. 7a). By means of such deposits, the movability of the O-ring 53 in the axial direction relative to the housing projection 63 can be impaired. The slide ring 16, however, must be able to move, even if only a little bit, in order to be able to follow the possible positional deviations of the counter ring 18. The lubricant reservoir 72 provided in the embodiment according to FIG. 7b prevents the collection of deposits in this area so that the O-ring 53 can perform the required axial movements relative to the housing projection 63.

Since the secondary seal 52 seals on the housing projection 63, the anti-rotation protection for the slide ring 16 can be provided on the inner contour of the mounting space 12 of the pump housing 11. The wall 13 of the mounting space 12 has accordingly a non-round, in particular, polygonal, contour and the outer wall 41 of the slide ring 16 matches this contour. Since the anti-rotation protection is provided in the outer area of the face seal, the face seal can be inserted during assembly easily into the pump housing 11 because the positive-locking engagement means are not covered by the counter ring 18. Its outer diameter is smaller than the outer diameter of the slide ring 16. Because of the externally located positive locking action, the maximum possible leverage is provided for the friction moment transmission so that the mechanical load is reduced. This is a significant advantage in regard to a pump housing 11 made from plastic material.

In the described embodiments, the slide ring 16 and the counter ring 18 are designed differently so that upon assembly of the face seal no assembly errors are possible. Even when the slide ring 16 and the counter ring 18 have the same shape, erroneous placement of the sealing parts during assembly is not possible. In this case, the sealing partners would magnetically repel one another.

Should the corrosion resistance of the two magnets 16, 18 used as a sliding pair be insufficient, a corrosion protection can be applied, for example, by electroplating, by powder coating, by applying a protective enamel or the like. This corrosion protection coating can be applied after finish machining the sliding surfaces 17, 20 so that all surfaces of slide ring 16 and counter ring 18 are coated and protected. This is particularly expedient when the coating improves the tribologic properties of the sliding pair, in particular, during running-in of the sliding pair. The coating, of course, can also be applied before finish machining of the sliding surfaces 17, 20. In this case, the coating is removed in the area of the sliding surfaces 17, 20 during machining. However, this does not effect the tribologic properties of the sliding pair in any way.

It is also possible to provide a coating of the sliding pair that improves the tribologic properties of the sliding pair deliberately. These coating processes, such as PVD (physical vapor deposition); DLC (diamond-like carbon coating), plasma spraying and the like are used as a standard procedure for improving the sliding properties and the wear resistance. It is also advantageous that such coatings are very thin, for example, several μm up to approximately 0.2 mm, and that they therefore affect the magnetic force only to a negligible extent.

Moreover, in order to improve the tribologic properties of the sliding pair, different magnetic materials can be used for the slide ring 16 and the counter ring 18, respectively.

Since the seal gap closing force is dependent only on the magnetic force itself and does not depend on component tolerances/variations or mounting tolerances/variations, the seal gap closing force can be selected to be much lower so that the sealing gap temperature and wear are significantly reduced.

While specific embodiments of the invention have been shown and described in detail to illustrate the inventive principles, it will be understood that the invention may be embodied otherwise without departing from such principles.

What is claimed is:

1. A face seal for cooling medium pumps of motor vehicles, the face seal comprising:
a slide ring;
a counter ring, wherein the slide ring and the counter ring are forced seal-tightly against one another by a magnetic force of attraction.

2. The face seal according to claim 1, wherein the slide ring and the counter ring are magnets.

3. The face seal according to claim 1, wherein a first one of the slide ring and the counter ring is a magnet and wherein a second one of the slide ring and the counter ring is made from ferromagnetic material.

4. The face seal according to claim 1, further comprising a secondary seal, wherein the slide ring is secured by the secondary seal.

5. The face seal according to claim 4, wherein the secondary seal engages an end of the slide ring facing away from the counter ring.

6. The face seal according to claim 4, comprising a pressure chamber for the medium to be sealed, wherein the secondary seal seals the pressure chamber relative to an air side of the face seal.

7. The face seal according to claim 4, wherein the secondary seal is a folded-over bellows-shaped seal.

8. The face seal according to clean 7, wherein the secondary seal is L-shaped in axial section.

9. The face seal according to claim 4, wherein the secondary seal comprises a pressure chamber.

10. The face seal according to claim 9, wherein the pressure chamber is closed in a direction toward a shaft to be sealed by the face seal.

11. The face seal according to claim 9, wherein the pressure chamber is open toward a medium side of the face seal.

12. The face seal according to claim 9, wherein the pressure chamber has an inlet provided with spacers that keep the inlet open.

13. The face seal according to claim 12, wherein the spacers are ribs.

14. The face seal according to claim 9, wherein a pressure in the pressure chamber loads the slide ring in a direction toward the counter ring.

15. The face seal according to claim 9, further comprising a securing ring arranged in the pressure chamber, wherein the securing ring is positioned coaxially to a shaft to be sealed by the face seal, and wherein the securing ring has a diameter that is smaller than a diameter of the slide ring.

16. The face seal according to claim 7, wherein the secondary seal has at least one elastically deformable section that seals relative to the slide ring.

17. The face seal according to claim 4, wherein the secondary seal has a first sealing lip.

18. The face seal according to claim 17, wherein the first sealing lip separates a pressure chamber from the medium side of the face seal.

19. The face seal according to cling 18, wherein the first sealing lip forms an overflow valve that, when a predetermined pressure is surpassed at the medium side, opens toward the pressure chamber.

20. The face sealed according to claim 18, wherein the secondary seal has a second sealing lip that separates the pressure chamber from an air side of the face seal.

21. The face seal according to clean 20, wherein the second sealing lip loads the slide ring in a direction toward the counter ring.

22. The face seal according to claim 4, wherein the secondary seal has an O-ring sealing the slide ring radially inwardly.

23. The face seal according to claim 22, wherein the slide ring has a recess and wherein the O-ring is positioned in the recess with elastic deformation.

24. The face seal according to claim 23, wherein the recess is provided on a side of the slide ring facing away from the counter ring.

25. The face seal according to claim 22, wherein the secondary seal further comprises at least one underpressure support adjoining the O-ring.

26. The face seal according to claim 25, wherein the underpressure support is adapted to rest with at least one support part against a housing wall of the face seal or a housing wall of a pump housing in which the face seal is arranged.

27. The face seal according to claim 26, wherein the underpressure support is ring-shaped and axially delimits a lubricant reservoir of the face seal.

28. The face seal according to claim 27, wherein the lubricant reservoir is annular and extends axially between the underpressure support and the O-ring.

29. The face seal according to claim 1, further comprising a seal housing adapted to be pressed into a mounting space of a pump housing.

30. The face seal according to claim 29, wherein the slide ring is connected by an anti-rotation device to a radially inner housing wall of the seal housing.

31. The face seal according to claim 30, wherein the anti-rotation device is configured as a non-round contour of the radially inner housing wall and of a radially inner wall of the slide ring.

32. The face seal according to claim 4 without a seal housing, wherein the face seal is adapted to be inserted into a mounting space of a pump housing.

33. The face seal according to claim 32, wherein the slide ring has a radially inner wall that is configured to be connected to a housing projection of the pump housing so as to be secured against rotation relative to the housing projection.

34. The face seal according to claim 32, wherein the slide ring is fixedly secured by the secondary seal on a radially outer wall of the mounting space of the pump housing.

35. The face seal according to claim 32, wherein the slide ring has a radially outer wall that is configured to be connected to a radially outer wall of the mounting space of the pump housing so as to be secured against rotation relative to the mounting space.

36. The face seal according to clean 32, wherein the secondary seal has an O-ring and wherein the slide ring is secured by the O-ring radially inwardly on the housing projection.

37. The face seal according to claim 1, further comprising a centering part that secures the counter ring.

38. The face seal according to claim 37, wherein the centering part is secured on a seal housing of the face seal or on a pump housing that receives the face seal.

39. The face seal according to claim 37, further comprising a seal housing, wherein the centering part is secured on the seal housing and is adapted to be secured to a pump housing that receives the face seal.

40. The face seal according to claim 37, wherein the centering part delimits a dry run reservoir.

41. The face seal according to claim 1, wherein the slide ring is axially movable.

42. The face seal according to claim 1, wherein the slide ring is tiltable to a limited extent.

43. The face seal according to claim 1, wherein the slide ring and counter ring are composed of different magnetic materials, respectively.

44. The face seal according to claim 1, wherein at least one of the slide ring and the counter ring is provided with a corrosion protection coating.

45. The face seal according to claim 1, wherein the slide ring is loaded in a direction toward the counter ring by a medium contained in a pressure chamber of the face seal as a function of a pressure present at a medium side of the face seal.

46. The face seal according to claim 1, wherein a closing force at a seal gap between the slide ring and the counter ring is automatically adjusted as a function of a pressure of a medium to be sealed by the face seal.
